(19) United States
(12) Patent Application Publication
(10) Pub. No.: US 2014/0262995 A1
(43) Pub. Date: Sep. 18, 2014

(54) Valve Assembly of a Filter Element

(71) Applicant: MANN+HUMMEL GMBH, Ludwigsburg (DE)

(72) Inventor: Mahdi Abokhalaf, Ludwigsburg (DE)

(73) Assignee: MANN+HUMMEL GMBH, Ludwigsburg (DE)

(21) Appl. No.: 14/208,875

(22) Filed: Mar. 13, 2014

(30) Foreign Application Priority Data
Mar. 13, 2013 (DE) 10 2013 004 285.2

(51) Int. Cl. F16K 15/02; B01D 35/147; B01D 35/153

(52) U.S. Cl. CPC F16K 15/028; B01D 35/153; B01D 35/1475
USPC 210/136; 137/537; 137/542

(57) ABSTRACT

A valve assembly of a filter element has a valve plunger with a valve stem provided with a coupling section and a valve plate connected to the valve stem and designed to close a valve opening. The valve assembly has a spring element with a spring section for generating a restoring force and a holding section for mechanically coupling the spring element to the coupling section of the valve plunger. The valve stem is enclosed at least partially by the spring section. The holding section and the coupling section engage each other such that the spring section generates a restoring force along a center axis of the valve assembly that forces the valve plate against a rim of the valve opening.

### CROSS-REFERENCE TO RELATED APPLICATION

This application claims the benefit of prior filed German patent application No. 10 2013 004 285.2 filed Mar. 13, 2013, the entire contents of the aforesaid German patent application being incorporated herein by reference.

### BACKGROUND OF THE INVENTION

The present invention concerns a valve assembly, for example, for use as a pressure relief valve, which is arranged in or on a filter. In particular liquid filters, for example, for oil, fuel, or urea solutions in the automotive sector, can be provided with the valve assembly.

In order to dissipate pressure fluctuations in filter systems, check valves or pressure relief valves are provided in filter housings or filter elements themselves. In case of clogging or excessive loading of filter elements, pressure relief valves are provided, for example, that are designed to reliably open so that the filter system will not be damaged. Particularly when valves are integrated in disposable filters, a simple configuration and an inexpensive manufacture are desirable.

Check valves for a fuel supply are, for example, disclosed in DE 10 2004 004 103 A1 in which an elastic valve body comprised of a hollow ball is forced by means of a spring against a valve opening. In an open position of this valve assembly, a minimal flow resistance due to the deformation of the valve body results. In addition to good flow-through properties, a simple manufacture and simple handling of the valve should however be provided also.

### SUMMARY OF THE INVENTION

It is therefore an object of the present invention to provide alternative or improved valve devices.

Accordingly, a valve assembly with a valve plunger, which comprises a valve stem with a coupling section and a valve plate for closing a valve opening, and with a spring element, which comprises a spring section for generating a restoring force and a holding section for mechanically coupling to a coupling section, is provided. In this context, the valve stem is at least partially surrounded by a spring section, and the holding section and the coupling section engage each other such that the spring section generates a restoring force along a center axis of the valve assembly for forcing the valve plate against the valve opening.

The valve assembly can be provided and/or integrated in particular as a check valve or pressure relief valve in a filter system, on a filter element or a filter housing.

The valve assembly is used, for example, in operating medium filters for motor vehicles, for example, oil filters or fuel filters, as a bypass valve and non-return valve.

Since the holding section and the coupling section engage each other, a low-expense manufacture or a beneficial assembly of the two elements valve plunger and spring element can be realized, on the one hand. On the other hand, a reliable sealing seat between valve plate and a sealing surface on the valve opening is achieved. For example, a rim of the valve plate as a first sealing surface is forced by means of the spring force of the spring element against a valve opening rim as a second sealing surface. In embodiments, the spring is tensioned in this context between a valve opening rim and the coupling section. In embodiments, a sealing seat between valve opening and valve plate is ensured wherein the restoring force of the spring pulls the valve plate in the direction toward a housing interior against the flow direction.

The coupling section of the valve stem is provided, for example, with an undercut that surrounds partially with positive fit the holding section that is, for example, straight. In the valve assembly, a coupling point between the holding section and the coupling section results preferably on the center axis of the valve assembly. In this way, a particularly good and reliable force transmission between spring element and valve plunger is provided.

In embodiments of the valve assembly, the coupling section is embodied as a hook that at least partially encloses the holding section. Furthermore, a barb can be provided so that the coupling section, as soon as it engages the holding section, is secured by a barb. This can also be referred to as a snap-on action or clip-on action of the holding section, for example, a straight piece of wire, with a valve plunger that is made of plastic material. A snap-on action is realized preferably perpendicular to the spring axis or center axis of the valve assembly. By means of a snap-on action or engagement of the elements with each other, an easy assembly of the valve plunger and of the spring element can be achieved wherein the rim of a valve opening extends between the valve plate and a support section of the spring element.

Preferably, the coupling section is shaped such that, upon joining of the valve plunger and the holding section within the spring section along the center axis, the spring element and the valve plunger are rotated relative to each other and the holding section glides into an engagement area of the coupling section.

Preferably, upon assembly or coupling of the valve plunger with the holding section an automatic positioning of the holding section and of the coupling section relative to each other results so that the holding section glides into the engagement area that is, for example, hook-shaped or formed with an undercut or like a carabiner. The coupling section can moreover be shaped geometrically such that the holding section, which is designed as a wire extending perpendicularly to the center axis or spring axis, automatically glides onto a guide path and reaches the engagement area of the coupling section. Accordingly, upon assembly, without having to determine the orientation of spring element and valve stem relative to each other beforehand, a simple coupling action and engagement can be realized.

In the valve assembly, the holding section preferably exerts a spring force against the coupling section in the direction away from the valve plate. This means that in embodiments the spring is compressed and pulls the valve plate against the rim of the valve opening in the direction toward the coupling section of the valve plunger.

In embodiments, the valve stem comprises moreover projecting guide ribs for securing the spring section. The valve stem ensures thus centering of the spring axis and of the axis of the valve plunger on the center axis of the entire valve assembly. Canting of the valve plunger upon opening and closing of the valve is thus prevented.

Embodiments of the employed spring element comprise spiral springs, in particular spiral pressure springs, coil springs, evolute springs, plate springs, membrane springs, air springs or annular springs.

In the valve assembly, the holding section can comprise a straight spring piece which is projecting from the spring section embodied as a spiral spring in the direction toward the center axis. For example, the spring element is substantially a spiral spring wherein at one end a holding section is provided that is formed as a straight piece extending diametrically. The holding section is preferably positioned perpendicular to the center axis or symmetry axis of the spiral spring. Thereby, together with the coupling section, a centering action of the force transmission between spring and valve plunger is reliably achieved.

The valve assembly comprises in embodiments moreover a valve housing comprising the valve opening. The valve housing has a sleeve-shaped or tubular section which surrounds the spring element. For example, the sleeve-shaped section can be a cylinder which is projecting from a filter end disk wherein the valve opening is provided in the base surface of the cylinder.

The sleeve-shaped section comprises in embodiments guide ribs oriented in the direction toward the spring element for holding the spring element. Accordingly, a reliable guiding action and centering action of the spring element is enabled so that a tilted position or canting is practically reliably prevented. For example, preferably three guide ribs are provided on the sleeve-shaped section of the valve housing and/or three guide ribs are provided which project from the valve plunger. The cylinder axis of a helix or a spiral line is provided as a center axis of the valve assembly, for example. Preferably, the center axis extends through the center of gravity of the spring element, valve plunger, and sleeve section.

The valve plunger and/or the valve housing in embodiments are at least partially manufactured of an injection-moldable material. For example, polypropylene, polyethylene, polyimide, polyamide or PET is suitable.

Furthermore, a filter element is proposed which comprises at least one end disk into which a valve assembly as described above is integrated. Moreover, the valve assembly in embodiments is part of a filter element or a filter device, in particular, for filtering operating media of motor vehicles.

Further possible implementations of the invention comprise also combinations not explicitly mentioned of features or embodiment variants described above or in the following. In this context, a person of skill in the art will also add individual aspects as improvements or supplements to the respective basic embodiment of the invention.

Further embodiments of the invention are subject matter of the dependent claims as well as of the embodiments of the invention described in the following. In the following, the invention will be explained in more detail with the aid of embodiments with reference to the attached Figures.

### BRIEF DESCRIPTION OF THE DRAWINGS

FIG. 1 is a perspective partial section view of an embodiment of a filter element with a valve assembly.

FIG. 2 is a perspective view of an embodiment of a valve stem for a valve assembly according to FIG. 1.

FIG. 3 is a perspective view of an embodiment of a spring element for a valve assembly according to FIG. 1.

FIG. 4 is a perspective view of an embodiment of a valve housing for a valve assembly according to FIG. 1.

FIG. 5 is a further perspective partial section view of the valve assembly according to FIG. 1.

FIG. 6 is a partial cross-section view of the valve assembly according to FIG. 1.

FIG. 7 is a cross-sectional view of the valve assembly according to FIG. 1.

FIG. 8 is a further perspective view of the valve assembly according to FIG. 1.

In the Figures, same reference characters refer to same or functionally the same elements, inasmuch as nothing to the contrary is indicated.

### PREFERRED EMBODIMENT OF THE INVENTION

In the following, one embodiment of the valve assembly will be explained in more detail with the aid of the Figures.

FIG. 1 shows an embodiment of a filter element 30 with a valve assembly in a perspective overview illustration. The valve assembly 1 has in this context along a valve axis or a center axis 19 a valve plunger 2 which is illustrated in detail in FIG. 2. The valve plunger 2 is surrounded by a spring element 7 which is designed as a spiral spring and which is illustrated in more detail in FIG. 3.

The valve assembly 1 serves to close off a valve opening 6 by means of a valve plate 5 arranged on the valve plunger 2 and connected to the valve stem 3. The valve opening 6 is part of a valve housing 10 that is illustrated in FIG. 4 in more detail. The valve housing 10 has in this context a sleeve-shaped or tubular section 11 that comprises the valve opening 6 at the head. The valve housing 10 can be part of a filter end disk, for example, or can form the end disk of the filter element 30 According to FIG. 1, a folded star-shaped filter medium 31 is embedded seal-tightly at an end face of the valve housing 10. For example, the other end face of the filter element 31 can be embedded in a second end disk (not shown).

In the closed state of the valve assembly 1, the valve plunger 2 with the valve plate 5 is forced against the valve opening 6 and ensures a sealing seat. The sleeve-shaped section 11 surrounds in this context valve plunger 2 and spring element 7.

The spring element 7 is embodied as a coil pressure spring and comprises a spring section 8, which generates upon tensioning a restoring force F along the center axis 19, and a straight holding section 9, which extends from the spiral line of the spring section 8 radially inwardly toward the center axis 19 that is also the spring axis. The holding section 9 intersects in this context the center axis 19.

In FIG. 4, one can moreover see that guide ribs 14 extend from the inner side of the sleeve-shaped section 11 and guide and support the spring element 7 externally. The inner side of the spring element 7 is guided by means of guide ribs 15 wherein the guide ribs 15 project radially away from the valve stem 3. In the assembled state, as illustrated in FIG. 1, a straight holding section 9 of the spring element 7 and a coupling section 4 of the valve plunger 2 engage each other.

FIG. 2 shows the valve plunger 2 more clearly. Essentially, the valve plunger 2 comprises a straight valve stem 3 from which the guide ribs 15 project outwardly. In the orientation of FIG. 2, the valve plate 5 is provided at the bottom and comprises a sealing surface 12 which in the assembled state rests seal-tightly on a sealing surface 13 of the valve opening 6 (compare FIG. 1). Distal to the valve plate 5, the valve plunger 2 has the coupling section 4. The coupling section 4 forms quasi an end member or a head of the valve stem 3. The coupling section 4 is formed such that an engagement area or hook 16 is produced which is engaged by the straight holding section 9 of the spring element 7.

The valve plunger 2 or the coupling section 4 has moreover a guide wall 18 which delimits a guide path 21 along which the straight holding section 9 upon assembly of the valve plunger 2 within the spring element 7 slides or glides in the direction toward the center axis 19 and then is snapped on or locked in the engagement area 16. In this context, the head or topside 17 of the coupling section 4 is shaped such that the holding section 9 slides in the direction toward the guide wall 18 and is thereby oriented such or valve plunger 2 and spring element 7 rotate relative to each other such that the holding section 9 slides into the undercut or engagement area or hook 16. Accordingly, upon mutual approach along the center axis 19 a mutual deflection movement occurs which leads to the correct seat of the holding section 9 relative to the guide path 21.

When assembling the valve assembly 1, the spring element 7, in the orientation of FIGS. 1 through 4, can thus be inserted first from the top into the sleeve-shaped or tubular section 11 wherein the guide ribs 14 ensure centering along the center axis 19. Subsequently, the valve stem 3 is guided through the valve opening 6. The spring element 7 is optionally compressed along the spring axis 19 and the holding section 9 as well as the coupling section 4 with the appropriately shaped head surfaces 17 and guide wall 18 engage each other such that the holding section 9 glides into the engagement area 16 and is hooked thereat.

In the assembled state, as illustrated in FIG. 1, a sealing seat between the sealing surface 13 and the sealing surface 12 or between the valve housing 10 and the valve plate 5 is provided. The restoring force F of the spring element 7 which is substantially generated by the spiral spring section 8 ensures a reliable sealing seat. When in operation of a filter, for example, an excessive pressure is generated in the orientation of FIG. 1 above the valve housing 10, the valve plate 5 can release the valve opening 6 of the valve 1 against the restoring force F of the spring.

With the aid of the section views in FIGS. 5, 6, and 7, one can see, beyond the illustration of FIG. 1, how the guide ribs 14 on the inner side of the sleeve-shaped section 11 support or guide the spring section 8. This can be seen also in FIG. 8 which shows a perspective plan view of the valve housing 10 in the direction toward the valve opening in the sleeve-shaped section that is hidden herein. Three guide ribs 14 are provided which are positioned spaced at an angle α of 120° relative to each other. The radially inwardly oriented guide forces of the guide ribs 14 compensate each other thereby. In this way, a stable position of the spring element 7 is achieved. Preferably, three guide ribs 14 are provided but more than three can be provided also. In analogy, a guiding action or supporting action of the spring element 7 is provided by the inner side by means of the ribs 15 which are provided on the valve stem 3 preferably at an angle spacing of 120° relative to each other. This can be seen in particular in FIGS. 6 and 7.

With regard to the configuration of the coupling section 4, in the section views of FIGS. 6 and 7, a guide path 21 resulting from the guide section or guide wall 18 as well as the engagement area 16 is shown. The guide path 21 is formed such that the straight holding section 9 upon insertion glides in the direction to the center axis 19 and hooks thereat perpendicular to the center axis 19. With this centering action it is achieved that the restoring force F, which is generated in particular by the spring section 8, is generated mainly coaxially to the center axis 19. Accordingly, even for lifting and lowering of the valve plate 5 at different pressure situations no canting of the valve stem 3 and/or of the spring element 7 will occur.

The guide surface 20 which is present in FIG. 7 at the top of the coupling section 4 is also formed such that the holding section 9 upon assembly is gliding in the direction toward the guide path 21. Accordingly, a particularly simple and low-expenditure assembly of the entire valve assembly 1 can be realized. An automatic positioning of the spring end piece or holding section 9 is obtained when assembling the valve plunger 2 and the spring element 7 by insertion of the valve plunger 2 into the spring element 7. Upon assembly, a deflection movement results which, as a result of the interaction of the holding section 9 with the coupling section 4, can lead to a rotation of the valve plunger 2 and the spring element 7. A correct positioning upon insertion results. Laterally, a good guiding action of the valve assembly and thus centering action of the axes of valve plunger 2, spring element 7, and sleeve 11 by means of inwardly or outwardly projecting guide ribs 14, 15 results. The connection or coupling between spring element 7 and valve plunger 2 is done by clip-on action, snap-on action, or hooking of the coupling section 4 and the holding section 9.

Even though the present invention has been explained with the aid of various embodiments, it is not limited thereto but can be modified in many ways. For example, spring types other than the aforementioned ones can be employed.

What is claimed is:

1. A valve assembly of a filter element, the valve assembly comprising:
a valve plunger comprising a valve stem with a coupling section and further comprising a valve plate connected to the valve stem, wherein the valve plate is adapted to close off a valve opening;
a spring element comprising a spring section and a holding section connected to the spring section, wherein the holding section is mechanically coupled to the coupling section and wherein the spring section encloses at least partially the valve stem;
wherein the holding section and the coupling section engage each other such that the spring section generates a restoring force along a center axis of the valve assembly that forces the valve plate against a rim of the valve opening.

2. The valve assembly according to claim 1, wherein the coupling section is a hook that at least partially encloses the holding section.

3. The valve assembly according to claim 1, wherein the coupling section is formed such that, when the valve plunger and the holding section are joined by inserting the valve plunger into the spring element along the center axis, the spring element and the valve plunger are rotated relative to each other and the holding section glides into an engagement area of the coupling section.

4. The valve assembly according to claim 1, wherein the holding section exerts a spring force against the coupling section in a direction away from the valve plate.

5. The valve assembly according to claim 1, wherein the valve stem has projecting guide ribs that hold the spring section.

6. The valve assembly according to claim 1, wherein the spring section is a spiral spring and the holding section is a straight spring piece that projects from the spiral spring in a direction toward the center axis.

7. The valve assembly according to claim 1, further comprising a valve housing that is provided with the valve opening, wherein the valve housing comprises a sleeve-shaped section which encloses the spring element.

8. The valve assembly according to claim 7, wherein the sleeve-shaped section comprises guide ribs, oriented in a direction toward the spring element, and wherein the guide ribs holds the spring element.

9. The valve assembly according to claim 1, wherein the valve stem projects through the valve opening.

10. The valve assembly according to claim 1, wherein the spring section is compressed within the valve assembly relative to an untensioned state of the spring element.

11. A filter element comprising an end disk having integrated therein a valve assembly according to claim 1.
